(19) United States
(12) Patent Application Publication
(10) Pub. No.: US 2007/0297756 A1
(43) Pub. Date: Dec. 27, 2007

(54) Content representing method and system

(75) Inventor: Naoto Kinjyo, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/802,882

(22) Filed: May 25, 2007

(30) Foreign Application Priority Data
May 26, 2006 (JP) 2006-146957

(51) Int. Cl. H04N 5/93; G11B 27/00

(52) U.S. Cl. 386/52

(57) ABSTRACT

A content representing method and system allow a quick reference to contents recorded in a recording medium without loading it in a reproducing apparatus for playback. The contents are recorded on a first recording surface of a double-sided recording medium whereas identification information for identifying the recording medium is recorded on a second recording surface. The identification information is stored in link with contents data. Identification information, which is obtained by shooting the recording medium, is used, when it is inputted, to retrieve the contents data linked with it from the storage. Contents data detected by retrieve is used to reproduce/represent the contents recorded in the recording medium.

The entire contents of documents cited in this specification are incorporated herein by reference.

### BACKGROUND OF THE INVENTION

The present invention relates to a content representing method and a content representing system and, more specifically, to a method and a system for reproducing/representing contents contained in storage media in which contents are stored or in recording media in which contents data is recorded.

Personal computers are acquiring ever higher performance and digital household electrical appliances such as digital image recording apparatuses now have gained a widespread use and further, network systems have achieved enhanced performance. With this backdrop, personal computers are now connected with a variety of household electrical appliances to form a so-called home network, exchanging various kinds of digital contents for recording, editing and reproduction.

For example, television sets may be connected to a personal computer and recording apparatuses with various recording media to record a television program first in the hard disc of the personal computer, do some editing including selection and synthesis on the recorded program, and then record it in a recording medium. Alternatively, a television program may be first stored in the hard disc of a DVD (digital versatile disc) recorder equipped with a hard disc, and then the television program or desired parts thereof are selectively recorded on a DVD.

It is also common practice by now to record images a user has produced by shooting with a digital video camera, a digital still camera or other like tool, which is connected to a home network after shooting, in recording media such as a CD-R (compact disc-recordable) or a DVD either as shot or with some editing done, or to record music data delivered over the Internet or music data a user has created in recording media such as a CD-R or an MD (mini disc).

Meanwhile, recording media now boast such a large capacity that a single recording medium alone is capable of recording a significantly large amount of contents. In addition, a DVD-RW, a CD-RW (compact disc-rewritable), an MD and other like recording media are rewritable. Thus, convenient though they are as far as data recording is concerned, such recording media have a shortcoming that unless loaded in a reproducing apparatus, they do not allow reference to the recorded contents, which causes inconvenience in data management and data retrieve or search.

To obviate such inconvenience, a name, for example, of the contents of a recording medium was written on its label for distinction. However, not only was writing names on the labels a bother, the space in each label permitted inclusion of such a limited amount of information that, subsequently, precise recognition of the contents could often proved a difficult task. In addition, when a single recording medium contained quite a few pieces of contents, the label could not hold all the necessary information. Furthermore, there were cases that after the trouble of writing information on the label of a recording medium was taken, its recorded contents were rewritten so that the label no longer agreed with the contents it was supposed to indicate.

JP 2003-101922 A describes a magnetic recording apparatus with an integrated camera that records in a video cassette a still image with which the recording starts in order to allow recognition of the recorded contents without having to play back the video tape. More specifically, the still image, e.g., an index image, with which the recording starts, is written into a semiconductor memory that is incorporated in the video cassette to ensure and facilitate the recording of the still image and allow a quick reproduction of the still image for recognition of the contents of the video tape.

JP 2003-101922 A discloses that a magnetic recording apparatus with an integrated camera saves the user the trouble of writing information indicative of recorded contents on a label or other like means as the user is permitted a reference to the still image for recognition of the recorded contents. Said magnetic recording device, however, presented a drawback that the use of the video cassette that must have a built-in semiconductor memory increased the manufacturing costs of the video cassette. In addition, recognition of the recorded contents required taking the trouble of loading the video cassette in a reading apparatus.

JP 2002-245747 A discloses a recording medium that has an image displaying device attached to its exterior to provide a recording medium with an integrated displaying section. The image displaying section indicates the contents of data recorded in the recording medium to allow an easy recognition of the contents of the recording medium. However, the hardware of the recording medium required a dedicated recording apparatus to achieve recording in the image displaying device, complicating the hardware and thus increasing the manufacturing costs.

### SUMMARY OF THE INVENTION

US 2005-0213934 A1 (U.S. Ser. No. 11/090,059; hereinafter referred to as “earlier application”) filed by the Applicant of the present application proposes a method and a system that effectively address the problems JP 2002-245747 A presented.

The method and the system disclosed in the earlier application obtain identification information of a recording medium in which contents are recorded and which is identifiable by an external appearance thereof from photographic image data obtained by photographing the recording medium, store the obtained identification information and contents data corresponding to the contents of the recording medium in storage means provided inside a home server in association with each other, search, when identification information of a certain recording medium obtained by photographing the recording medium is inputted, the storage means using the inputted identification information and detecting the identification information coinciding with the inputted identification information, reading, from the storage means, the contents data stored in association with the detected identification information and reproduce/represent contents of the certain recording medium based on the read contents data.

The method and the system described in the earlier application use photographic images of recording media as their identification information to manage the recorded contents of the recording media stored in the home server. Thus, recognition of recorded contents stored in a recording medium can be gained by shooting the recording medium with a portable equipment such as a personal digital assistant (PDA) and a cellular mobile phone or other like means having a shooting function in order to reproduce outline data of the recorded contents of the recording medium on the portable equipment. The earlier application thus proposes a very effective method and system that allow an easy recognition of the recorded contents without loading the recording medium in a reproducing apparatus.

The present invention has as an object to provide a content representing method and a content representing system that allow an easy identification of the recorded contents of a recording medium without the need to load the recording medium in a reproducing apparatus by recording an image that permits its identification on the recording medium by means of a laser beam for recording the information instead of shooting the recording medium as proposed in the earlier application.

To achieve the above object, a content representing method according to the present invention uses a recording medium having a first recording surface on which data can be recorded by means of a first recording light beam and a second recording surface on which data can be recorded by means of a second recording light beam, and comprises: a first recording step of recording contents on the first recording surface of the recording medium by means of the first recording light beam; a second recording step of recording identification information that permits identification of the recording medium on the second recording surface that is different from the first recording surface by means of the second recording light beam; a storing step of storing data of the identification information recorded in the second recording step in storage means in link with contents data corresponding to the content; a retrieving step of retrieving, when the identification information of the recording medium obtained by shooting the recording medium is inputted, the contents data linked with the inputted identification information of the recording medium from the storage means by searching the storage means using the inputted identification information of the recording medium (a retrieving (or searching) step of searching the storage means by using the inputted identification information of the recording medium to retrieve (detect) the contents data linked with the inputted identification information of the recording medium); a step of reproducing and representing the contents recorded in the recording medium using the detected contents data.

The first recording step and the second recording step are preferably executed using a same recording means.

The identification information for identifying the recording medium recorded in the second recording step is preferably image data.

Preferably, the second recording step is executed on a label side of the recording medium that is different from the normal data recording side by means of the recording light beam used for data recording in the first recording step.

Preferably, the contents are comprised of digital data, and the recording medium is capable of recording the digital data. The contents data corresponding to the contents is preferably outline data of the digital data that constitutes the contents.

Further, the contents are preferably reproduced/displayed by portable equipment having a shooting function, a reproducing/displaying function, and a data transmission and reception function.

The present invention can be embodied into a content representing system for implementing the above content representing method.

Thus, a content representing system according to the present invention is a content representing system for implementing the content representing method described above and comprises: a recording means for recording contents on the first recording surface of the recording medium and recording identification information of the recording medium on a second recording surface of the recording medium in a photographable form; a storage means for storing data of the identification information recorded in the recording means in link with contents data corresponding to the contents; a shooting means for shooting the recording medium; a control means for searching the storage means based on the identification information of the recording medium obtained by the shooting means, and retrieving (detecting and reading out) information of the contents stored in the storage means in link with the identification information (control means for retrieving information of the contents stored in the storage means in link with the identification information from the storage means based on the identification information of the recording medium obtained by the shooting means); and a reproducing and displaying means for reproducing and displaying the retrieved (read-out) information of the contents.

According to the present invention, identification information (data) of an image representing the external appearance of the recording medium and the like is stored in the storage device in the home server as well as is recorded on another surface of the recording medium than its data recording surface. Consequently, the contents recorded in the recording medium and the identification information of the recording medium can be stored in the home server in a set of linked information. This advantageously eliminates the need for an operation of shooting the recording medium as required in the invention described in the earlier application to link the identification information of the recording medium and the contents data at a registration (in a registration step) as will be defined later herein.

At a reference (in a reference step) as will be defined later herein, the present invention may use the same operation of shooting the recording medium and sending information so obtained to the home server as used in the invention described in the earlier application. Thus, shooting the recording medium with a portable equipment or other like means results in the outline data of the recorded contents being reproduced by the portable equipment without the need to load the recording medium in a reproducing apparatus, thus allowing an easy recognition of the recorded contents of the recorded medium.

### BRIEF DESCRIPTION OF THE DRAWINGS

The invention will be better understood by reference to the following description taken in conjunction with the accompanying drawings in which:

FIGS. 1A through 1C are schematic diagrams to illustrate an outline configuration of the content representing system according to an embodiment of the invention to implement the content representing method of the invention.

FIG. 2 is a flow chart illustrating a flow of operations according to an embodiment of the invention.

### DETAILED DESCRIPTION OF THE INVENTION

Now a content representing method and a content representing system according to the present invention will be described in detail based on preferred embodiments of the invention by referring to the accompanying drawings.

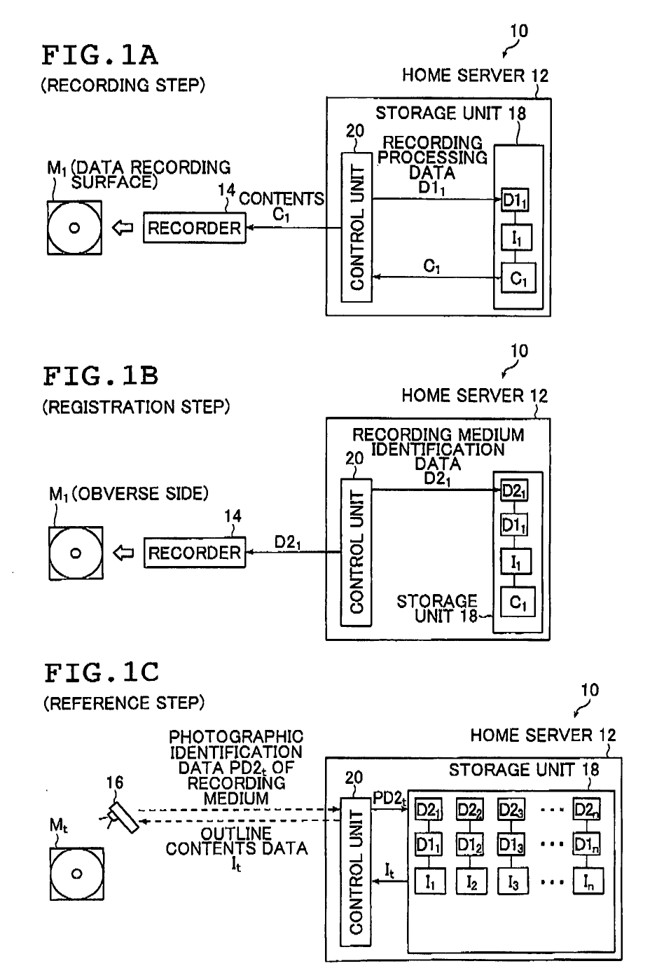

A content representing system 10 illustrated in FIG. 1 comprises a home server 12, a recorder 14, and a portable equipment 16. The content representing system 10 records primary contents data C stored in the home server 12 on a first recording surface of a recording medium M using a recorder 14. Then the content representing system 10 records identification information that enables identification of said recording medium M on a second recording surface of the recording medium M that is different from the first recording surface on which the primary contents data C is recorded.

Said identification information is stored and accumulated in the home server 12 as identification information D2 for identification of the recording medium N in link with outline data I of the primary contents data C. When, subsequently, one desires to refer to the contents recorded in the recording medium N, the identification information D2 of the recording medium N is used to retrieve or search data accumulated in the home server 12 to detect and represent the outline data I of the primary contents data C recorded in the recording medium M.

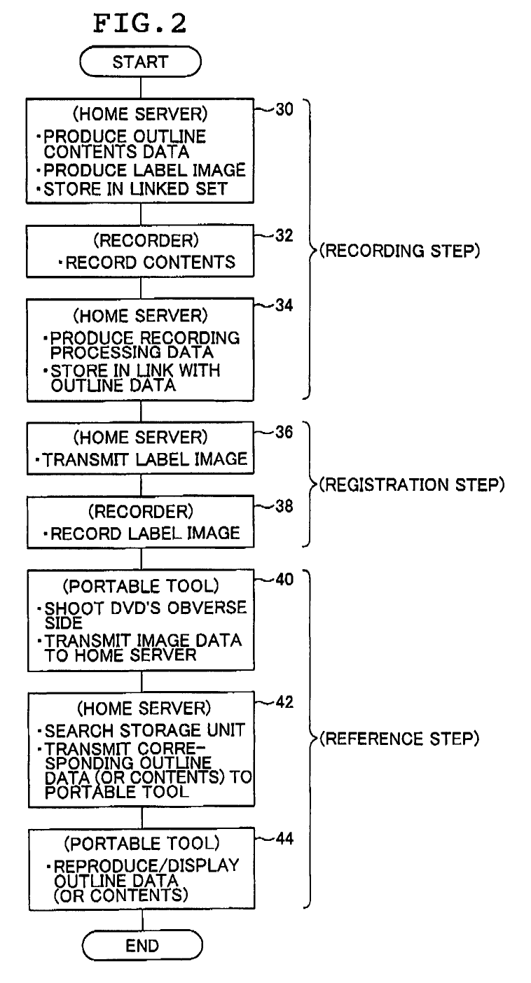

FIG. 2 illustrates a flow chart of the above operations. As illustrated in FIG. 2, the outline data I of the primary contents data C is first produced in the home server 12 and stored in link with the primary contents data C. Meanwhile, identification information of the recording medium N to be recorded in the recording medium M, e.g., an image of its label, is produced and stored in link with said outline data I (step 30).

In the following steps 32 and 34, said primary contents data C is transmitted to the recorder 14 for recording. Meanwhile, data related to recording processing is produced in the home server 12 and stored in link with said outline data I (step 34).

In steps 36 and 38, the identification information of said recording medium N is transmitted to the recorder 14 and recorded on a recording surface thereof different from that on which the primary contents data C is recorded.

At this stage, linkage between the recording medium having a piece of contents recorded therein and its recorded contents is achieved, and data related to the linkage is stored in the home server 12.

When, subsequently, a need arises to know the recorded contents of a certain recording medium, an inquiry or a reference operation based on said data related to the linkage in the home server 12 is executed.

The reference operation is started in step 40 in which a recording medium of interest is shot with the portable equipment 16. The image data acquired by shooting the recording medium is transmitted to the home server 12, where the transmitted data is analyzed for pattern recognition, pattern matching, and the like. Corresponding outline contents data I or the primary contents data C (the former and the latter being referred to herein broadly as information of the contents) is transmitted to the portable equipment 16 that has requested such data (step 42).

The portable equipment 16 reproduces/represents the outline data I or the primary contents data C according to said data transmitted to the portable equipment (step 44).

The flow of the content representing method according to an embodiment of the present invention has been briefly described above. Now the method will be described in detail below by referring to the configuration illustrated in FIG. 1.

The primary contents data (hereinafter referred to simply as “contents”) C is a digital file of data as exemplified by image data, sound data and program data that constitute contents such as moving images or still images; sounds including voice and music; and programs.

The outline contents data I is extracted data, compressed data, or other like data produced from the contents C or acquired at the time of acquisition of the contents C. Thus, the outline contents data I is of the same kind of data as the contents C but of a size greatly reduced as compared with the contents C, and allows quick recognition of the contents C. When, for example, the contents C are moving image data, the outline contents data I is moving image data as exemplified by pre-selected highlight scenes and index scenes of the respective chapters, whereby switching of scenes may be judged automatically, or still image data such as index images. When the contents C is still image data, the outline contents data I is reduced-size image data such as thumbnail images. When the contents C are sound data, the outline contents data I is sound data such as extracted data representing a given part of the contents C. When the contents C are a program, the outline contents data I is partial data thereof.

The home server 12 comprises a storage unit 18 and a control unit 20 and is connected to the recorder 14 via a connector (not shown) provided for data transmission and reception with the outside. The home server 12 also has a displaying section (monitor) and instruction inputting means (neither of them shown). The home server 12 may also be connected to other home appliances such as a television set, a printer, a digital camera and a personal computer besides the recorder 14. The home server 12 has functions to control the recorder 14 and may consist, for example, of a personal computer with a relatively high performance. When the home server is connected to other equipment besides the recorder 14, it may have functions to control such equipment as well.

The storage unit 18 has stored therein digital files as contents C (C₁, C₂, C₃, . . . Cₙ) Such digital files include digital image data, sound data, and programs acquired or produced using home appliances connected to the home server 12. In the storage unit 18 is also stored outline data I (I₁, I₂, I₃, . . . , Iₙ) that corresponds to the contents C. The contents C and the outline contents data I are separately configured so that even when the contents C are deleted from the storage unit 18, the outline contents data I is kept in the storage unit 18 until deliberately deleted by the user.

The control unit 20 performs various kinds of data processing in the home server including writing data into the storage unit 18, reading out data therefrom, data editing, data retrieve or search, and data detection, and controls data transmission and reception with external equipment. The control unit 20 also controls the recorder 14 connected to the home server 12.

Controlled by the control unit 20 of the home server, the recorder 14 records the contents C transmitted from the home server 12 in the recording medium M with or without editing. The recording medium M may be an optical recording medium such as a DVD-R, a CD-R, and an MD, or a magnetic recording medium such as a magnetic disc and a magnetic tape. The recorder 14 may for example be a hard disc-based DVD recorder formed integrally with the home server 12.

In the preferred embodiment under discussion, the portable equipment 16 used in the reference step as will be defined is a portable instrument having a shooting function, a sound/image reproduction and representing function, and a data transmission and reception function and is capable of data transmission and reception with the home server 12. The portable equipment 16 acquires photographic identification information PD2ₜ of the recording medium M by shooting the external appearance of the recording medium M and transmits the photographic identification information PD2ₜ to the home server 12. The portable equipment 16 receives data transmitted from the home server 12 to reproduce a sound such as music and/or reproduce and represent images. The data transmission and reception between the portable equipment 16 and the home server 12 may be done over a wired connection but are preferably performed wirelessly from a viewpoint of portability. Examples of wireless communications that may be used for that purpose include communications achieved directly between devices such as those over a wireless LAN, those using Bluetooth®, and infrared communications, as well as communications achieved over mobile phone lines, the Internet, and the like. The portable equipment 16 may be, for example, a mobile phone with a camera or a digital camera with communications capabilities.

Now, the operations of the content representing system 10 according to the preferred embodiment under discussion will be described.

FIG. 1A illustrates a step in which the contents C stored in the home server 12 is recorded in the recording medium M by the recorder 14 in the first recording process, which will be referred to simply as “recording step” below.

In the recording step, the contents C₁ stored in the storage unit 18 are read out by the control unit 20, sent to the recorder 14, and recorded on a first recording surface (the opposite side from the label side) of the recording medium M₁ by the recorder 14. Meanwhile, the control unit 20 produces recording processing data D1₁ that indicates the contents of C₁ recorded in the recording medium M₁ by the recorder 14. The recording processing data D1₁ produced is stored in the storage unit 18 in link with the outline data I₁ of the contents C₁ stored in the storage unit 18.

The recording processing data D1₁ preferably comprises time data, preferably expressed in increments of seconds, such as time data indicating the time at which recording processing is executed by the recorder 14 and the time at which the recording medium M₁ is unloaded from the recorder 14 after recording is finished and contents identification information such as the name of the contents C₁ or, in cases where two or more pieces of contents C are recorded, the names of the two or more pieces of contents C. When there is only one piece of contents C, the recording processing data D1₁ may consist of either the time data or the name of the contents.

The contents C₁ read out from the storage unit 18 to be recorded in the recording medium M₁ are deleted from the storage unit 18 either automatically or upon the user's instruction. Even when the contents C₁ are deleted from the storage unit 18, the outline data I₁ thereof and the recording processing data D1₁ are kept in the storage unit 18.

FIG. 1B illustrates a step (referred to herein as “registration step”) in which identification information D2₁ of the recording medium M₁ having the contents C₁ recorded therein is produced in the home server 12, and the identification information D2₁ and said recording processing data D1₁ produced and stored in the storage unit 18 in the recording step (at the recording) are stored and accumulated in a set of linked data in the home server 12, whereas by using the recorder 14, said identification information D2₁ of the recording medium M₁ is recorded on the label side of the identical recording medium M1 in which the contents C1 are recorded.

To record the identification information D2₁ of the recording medium M₁ on its label side, it is preferable to use “Labelflash”®, which is a commercially available laser-based recording system (software). Using the same recorder 14, the Labelflash enables recording data on both sides of a DVD of which the label side and the normal data recording side are both recordable. Data to be thus recorded generally include all kinds of digital data.

Using the Labelflash for the above recording brings the obvious advantage that it does not require any fresh recording device to record the identification information D2₁ of the recording medium M₁. A great advantage in using the Labelflash, moreover, is that it enables easy recording of the identification information D2₁ of the recording medium M₁ on the label side, i.e. obverse side, of a double-sided DVD in a desired format by using the same recorder 14 that is used to record primary data.

The recording medium M₁ in which the contents C₁ has been recorded by the recorder 14 and on whose label side (obverse side) its identification information D2₁ has been recorded is unloaded from a DVD recorder (not shown), completing all the processing to be done in the recording and registration steps. In the home server 12, the identification information D2₁ of the recording medium are stored (registered) in the storage unit 18 as a set of linked data with the recording processing data D1₁ previously stored in the storage unit 18.

The above identification information D2 of the recording medium M includes, where images are used, images selected from the index images in the outline data of the corresponding contents: images selected according to the size and the number of images and the kind of shooting subject as desired by the user; images added with art clip or other like ornamental patterns; and images each created by editing other images altogether than are contained in the recording medium. The identification information D2 must be able to allow recognition based upon the external appearance, i.e. data of a photographic image acquired in the reference step as defined below, and must therefore be distinctive in color, pattern, etc.

To ensure an easy distinction among the identification information D2, a prospective label image may be checked, for example, for similarity to the label images already in use, and in the event the prospective label image is found to have a similarity greater than a given degree of similarity to a label image in use, another index image may be selected automatically.

Thus, every time the contents C (C₁, C₂, C₃, . . . , Cₙ) stored in the storage unit 18 are recorded in the recording medium M (M₁, M₂, M₃, . . . , Mₙ), the recording processing data D1 (D1₁, D1₂, D1₃, . . . , D1ₙ) and the identification information D2 (D2₁, D2₂, D2₃, . . . , D2ₙ,) of the recording medium are produced and stored in the storage unit 18 in link with the outline data I (I₁, I₂, I₃, . . . , Iₙ) of the contents C. Thus, the outline data I of a plurality of pieces of contents C and the identification information D2 of the recording media M having the contents C recorded therein are accumulated in the storage unit 18.

FIG. 1C illustrates a step referred to herein as “reference step” in which, when one desires to know the contents recorded in a recording medium Mₜ (contents Cₜ), the home server 12 is searched using photographic identification information PD2ₜ of the recording medium Mₜ to detect and represent outline data Iₜ of the contents Cₜ recorded in the recording medium Mₜ.

After the contents C are thus recorded in a plurality of recording media M, and the outline data I of a plurality of pieces of contents C and their related data are accumulated in the storage unit 18, a reference to the contents (contents Cₜ) recorded in the recording medium Mₜ can be gained as follows. The external appearance of the recording medium Mₜ is first shot by the portable equipment 16. Then the photographic image data thus obtained is transmitted to the home server 12 as photographic identification information PD2ₜ.

In the home server 12, the control unit 20 compares the transmitted photographic identification information PD2ₜ of the recording medium with each identification information among a group of identification information D2 (D2₁ to D2ₙ) of n pieces of recording media stored in the storage unit 18 to detect identification information from among the group of identification information D2 that is the most similar to the photographic identification information PD2ₜ in image characteristics quantity or identical thereto in contents represented by a code or characters.

Upon detection of identification information D2 (D2ₜ) that corresponds to the photographic identification information PD2ₜ, the outline contents data Iₜ corresponding to recording processing data D1ₜ that is stored in a set with the identification information D2ₜ now detected is returned to the portable equipment 16, which in turn reproduces the outline contents data Iₜ.

The outline contents data I is reproduced in the form of still images, a moving image, a text, a sound such as music, or in a combined form of two or more of these items. Specifically, the portable equipment 16 shows images on a displaying section provided thereon (not shown) or reproduces a sound depending on the kind of outline contents data I and the capabilities the portable equipment 16 has. The portable equipment 16 may represent, for example, index images or a short moving image accompanied with a sound, or reproduce an introductory part of a piece of music. Thus, the user can recognize the contents (contents Cₜ) recorded in the recording medium Mₜ from the information thus reproduced.

When the contents C are moving image data, the outline contents data I, if desired, may preferably have a hierarchical structure or a tree structure as follows. The portable equipment 16 first shows an index of moving images of contents C constituting the individual pieces of contents C. When a particular piece of contents C is designated from the index, index images indicating representative frames from the respective chapters of that particular piece of contents are represented. Upon designation of a particular chapter, a simple moving image for that chapter such as a short moving image of a reduced picture quality is reproduced. The moving image may preferably be accompanied with a sound.

If desired, the recording time of each piece of contents and other supplementary information may also preferably be reproduced/represented. The supplementary information may be exemplified by the title of a program and the broadcasting station in the case of a recorded television program, and a shooting date/time and a shooting location in the case of a moving image produced by the user. It is also preferable to reproduce/represent the remaining free recording space in the recording medium M.

From a viewpoint of the user's convenience, the outline contents data Iₜ preferably is reproduced by the portable equipment 16 used to acquire the photographic identification information PD2ₜ of the recording medium Mₜ. When the outline contents data Iₜ has a number of images to be reproduced, however, monitoring means under the control of the home server may be used to represent the outline contents data Iₜ. It is also preferable that the outline contents data Iₜ is represented along with the recording processing data D1ₜ represented in characters.

In the above embodiment of the present invention, the identification information itself, such as image data, of the recording medium M recorded by the recorder 14 is stored in the storage unit 18 as the identification information D2 of the recording medium. When the above identification information is image data, however, image analysis data of that image data may instead be stored as the identification information.

More specifically, the above option may be implemented, for example, as follows. In the registration step, the control unit 20 performs code/character recognition on image data to be recorded on the obverse side of the recording medium M, and then the recognition data is stored in the storage unit 18 as identification information D2. Thus, in a subsequent reference step, the control unit 20 executes code/character recognition on the photographic image data of the recording medium Mₜ transmitted from the portable equipment 16 and compares the code/character recognition data with the identification information D2 stored in the storage unit 18 to detect identification information that matches the code/character contents.

Alternatively, the portable equipment 16 may be adapted to have a code/character recognition function so that in the reference step, photographic image data of the recording medium M is acquired by the portable equipment 16, followed by code/character recognition, and then the code/recognition data thus acquired is transmitted to the home server 12 as identification information D2. In the reference step under that option, the control unit 20 compares identification information D2t, i.e., the code/character recognition data transmitted from the portable equipment 16 with the identification information D2 stored in the storage unit 18, detecting identification information that matches the code/character contents.

While a content representing method and a content representing system according to the present invention have been described in detail by means of specific embodiments, it is to be understood that numerous changes and modifications may be made therein without departing from the spirit and scope of the invention.

What is claimed is:

1. A content representing method using a recording medium having a first recording surface on which data can be recorded by means of a first recording light beam and a second recording surface on which data can be recorded by means of a second recording light beam, comprising:
a first recording step of recording by means of the first recording light beam contents on the first recording surface of the recording medium;
a second recording step of recording by means of the second recording light beam identification information that permits identification of the recording medium on the second recording surface that is different from the first recording surface;
a storing step of storing data of the identification information recorded in the second recording step in storage means in link with contents data corresponding to the contents;
a retrieving step of retrieving, when the identification information of the recording medium obtained by shooting the recording medium is inputted, the contents data linked with the inputted identification information of the recording medium from the storage means by searching the storage means using the inputted identification information of the recording medium;
a step of reproducing and representing the contents recorded in the recording medium using the detected contents data.

2. The content representing method according to claim 1, wherein the first recording step and the second recording step are executed using same recording means.

3. The content representing method according to claim 1, wherein the identification information for identifying the recording medium recorded in the second recording step is image information.

4. The content representing method according to claim 1, wherein the second recording step is executed on a label side of the recording medium that is different from a normal data recording side by means of the first recording light beam used for recording the contents data in the first recording step.

5. The content representing method according to claim 1, wherein the contents are comprised of digital data, the recording medium is capable of recording the digital data, the contents data corresponding to the contents is outline data of the digital data that constitutes the contents.

6. The content representing method according to claim 1, wherein the contents are reproduced/represented by a portable equipment having a shooting function, a reproducing/representing function, and a data transmission and reception function.

7. A content representing system using a recording medium having a first recording surface and a second recording surface different from the first recording surface, on both of which data can be recorded, comprising:
recording means for recording contents on the first recording surface of the recording medium and recording identification information of the recording medium on a second recording surface of the recording medium in a photographable form;
storage means for storing data of the identification information recorded in the recording means in link with contents data corresponding to the contents;
shooting means for shooting the recording medium;
control means for searching the storage means based on the identification information of the recording medium obtained by the shooting means, and retrieving and reading out information of the contents stored in the storage means in link with the identification information; and
reproducing and representing means for reproducing and representing the read-out information of the contents.
